(19) United States
(12) Patent Application Publication
(10) Pub. No.: US 2007/0121274 A1
(43) Pub. Date: May 31, 2007

(54) Small volume thin film and high energy density crystal capacitors

(76) Inventors: John J. Talvacchio, Ellicott City, MD (US); James J. Murduck, Ellicott City, MD (US); Gregory C. DeSalvo, Joppa, MD (US); Rowland Chris Clarke, Sykesville, MD (US); Abigail Kirschenbaum, Baltimore, MD (US); Deborah P. Partlow, Crownsville, MD (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/484,597

(22) Filed: Jul. 12, 2006

Related U.S. Application Data
(60) Provisional application No. 60/697,994, filed on Jul. 12, 2005.

(51) Int. Cl. H01G 4/06

(52) U.S. Cl. 361/311

(57) ABSTRACT

Embodiments of the invention provide parallel plate capacitors comprising a bulk single crystal or single crystal film dielectric material disposed between the parallel plates and capacitors comprising one or more bulk single crystal or single crystal film dielectrics each disposed between two electrodes. Energy storage devices incorporating these capacitors also are disclosed.

This application claims the benefit of U.S. provisional application Ser. No. 60/697,994, filed Jul. 12, 2005.

### BACKGROUND OF THE INVENTION

1. Field of the Invention

The present invention relates to generally to energy storage devices, and, more specifically, to capacitors.

2. Discussion of the Background Art

Conventional energy storage devices for pulse power systems and other systems include large, counter-rotating flywheels, batteries, and banks of conventional high-voltage capacitors. A disadvantage of these and other conventional energy storage devices is that they are large and quite heavy. Accordingly, conventional charge storage devices limit the mobility of the system in which they are used.

There is a need in the art for energy storage devices that overcome the disadvantages of conventional energy storage devices and improve their energy storage per weight capability.

### SUMMARY OF THE INVENTION

Embodiments of the present invention provide materials for and energy storage devices that are small and light, yet able to store enough energy that they can be used in a wide range of applications, such as, for example, pulse power applications and other applications requiring large amounts of stored energy. In some embodiments, the invention provides an energy storage device that is not only smaller and lighter than conventional devices, but also has a significantly higher energy density than the conventional devices.

In one embodiment, the invention provides a parallel plate capacitor having a dielectric material disposed between the parallel plates, wherein the dielectric material is a bulk single crystal, for example a bulk single crystal of CaCu₃Ti₄O₁₂. In other embodiments, the dielectric material is a crystal film that may be a single crystal (e.g., a single crystal film of CaCu₃Ti₄O₁₂ or similar material)

The above and other features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, help illustrate various embodiments of the present invention and, together with the description, further serve to explain the principles of the invention and to enable a person skilled in the pertinent art to make and use embodiments of the invention. In the drawings, like reference numbers indicate identical or functionally similar elements.

FIG. 1 illustrates a capacitor 100 according to an embodiment of the invention.

FIG. 2 is a flow chart illustrating a process 200 for making a single crystal capacitor.

FIG. 3 shows a comparison between the energy density of commercially available capacitors and crystal capacitors with projected dielectric constants of 800, 8,000, and 80,000 (Emax=250 V/μm in all cases).

FIG. 4 illustrates an exploded schematic view of an energy storage device 500 that is designed to have a high energy density.

FIGS. 5A-5E are cross-section view schematic drawings which illustrate a process for making a multilayer capacitor according to an embodiment of the invention.

FIG. 6 is a cross-section illustration of an energy storage device according to embodiments of the invention.

FIG. 7 is a cross-section illustration of an energy storage device according to embodiments of the invention.

FIG. 8A provides a longitudinal cross-section view which illustrates an energy storage device according to embodiments of the invention. FIG. 8B is a top view of the embodiment illustrated in FIG. 8A. FIG. 8C is a top view of an energy storage device according to embodiments of the invention.

FIG. 9 is a plot showing specific power vs. specific energy for a number of energy storage technologies.

### DETAILED DESCRIPTION OF PREFERRED EMBODIMENTS

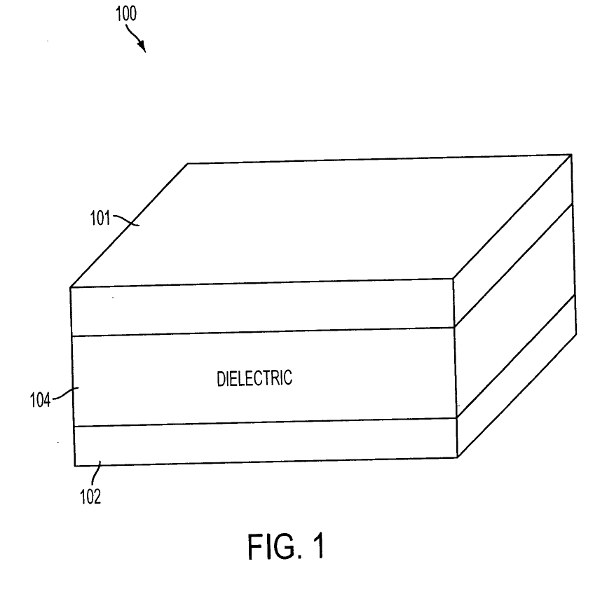

FIG. 1 illustrates a capacitor 100 according to an embodiment of the invention. Capacitor 100 includes a first electrode 101, a second electrode 102, and a dielectric 104 disposed between electrode 101 and electrode 102. In some embodiments, dielectric 104 is a bulk single crystal or single crystal film. In some embodiments, the bulk single crystal is in the form of a wafer.

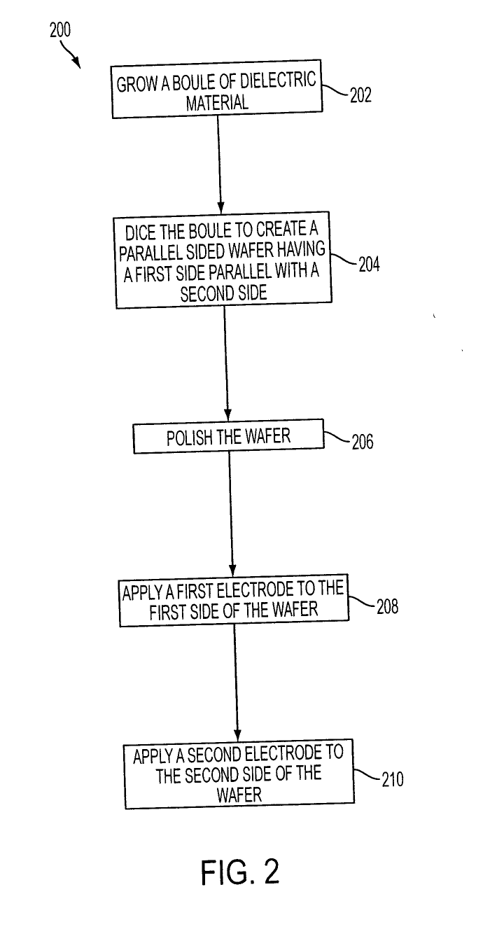

FIG. 2 is a flow chart illustrating a process 200 for making a single crystal capacitor. Process 200 may begin in step 202 where a boule of dielectric material is grown. In step 204, the boule is diced to create a parallel sided wafer having a first side parallel with a second side. In step 206, the wafer is polished. In step 208, a first electrode (conductive material) is applied to the first side of the wafer. In step 210, a second electrode is applied to the second side of the wafer.

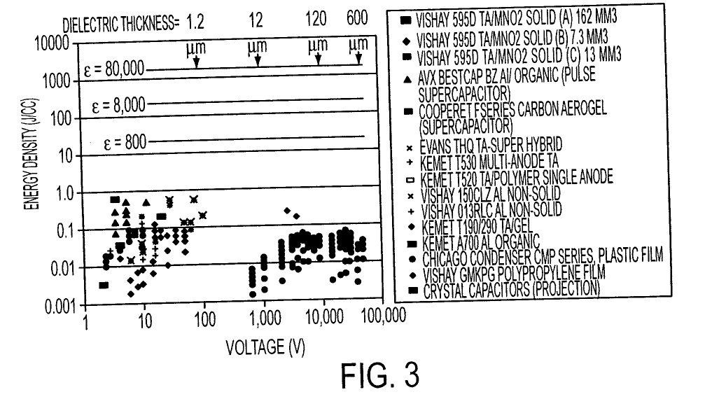

FIG. 3 compares the energy density of some selected commercially available capacitors with projected values for crystal capacitors. For any parallel plate capacitor, the energy/volume ratio is the product of the dielectric constant and the square of the maximum electric field, Eₘₐₓ. The calculations were made with assumed dielectric constants of 800, 8,000, and 80,000 (horizontal lines; Eₘₐₓ=250 V/μm in all cases) and a margin of safety in the electric field strength of a factor of 3.

This calculation of energy/volume considers only the volume of the dielectric material and ignores the volume needed for electrodes, packaging, and connectors. For high-voltage capacitors, those considerations could increase volume by as much as a factor of 2 or 3. That is, they have a small effect compared to the orders of magnitude larger energy density that could be obtained by using extremely high dielectric-constant materials. The conservative safety margin of a factor of three also could be used to account for these contributions to capacitor volume.

For low-voltage capacitors, a much more significant contribution to capacitor volume (excluded from FIG. 3) is the substrate that is needed to support dielectric layers that are too thin to be self-supporting. However, stacking thin-film capacitors with these high dielectric constants in multiple layers largely offsets the disadvantages of volume taken up by a substrate.

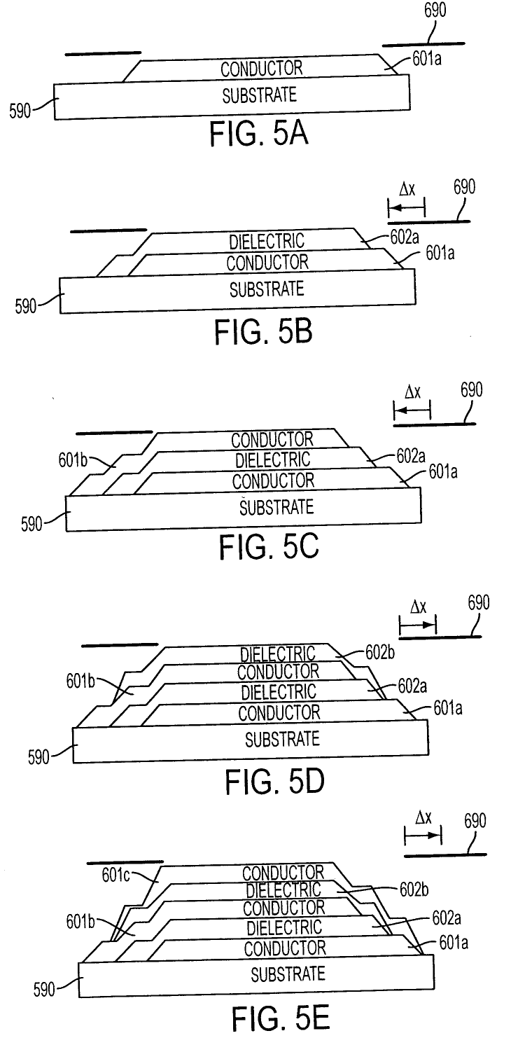

In addition to high energy densities, it is desirable for some applications to fabricate capacitor banks with high total stored energy corresponding to a large surface area of the capacitor dielectric. Since bulk single crystal dielectrics cannot be rolled or folded without destroying them, large capacity capacitors according to these embodiments are stacked with alternating layers of dielectric and conductor (electrode). The electrodes between each pair of dielectric crystals in a stack advantageously coat the edge of the wafers for access by a common electrical connection. A second set of electrodes (counter electrodes) preferably coat another edge of the wafers for contact by a second common connection. These features are illustrated in FIG. 5.

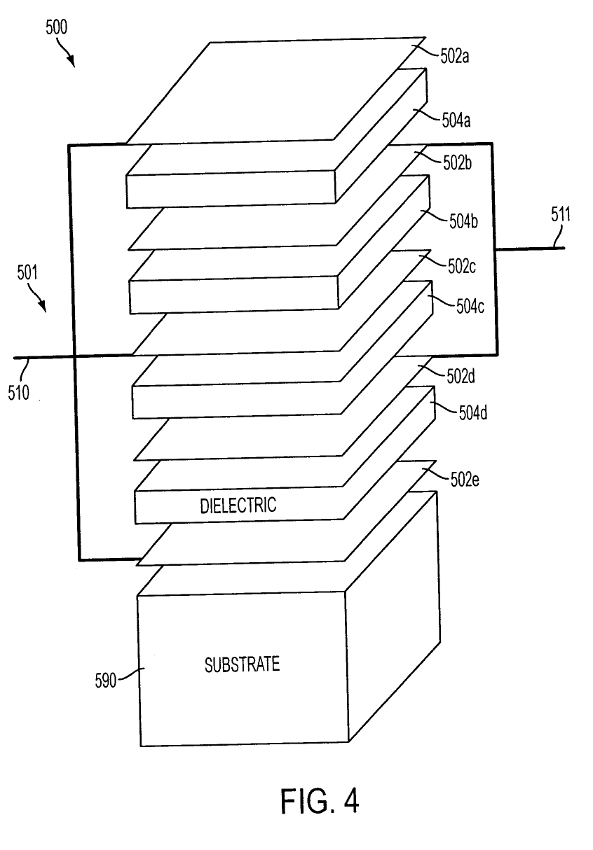

FIG. 4 illustrates an exploded schematic view of a stacked (multilayer) energy storage device 500 that is designed to have a high energy density. As shown in FIG. 4, device 500 includes a multilayer capacitor 501. Multilayer capacitor 501 includes a number of electrode layers 502 (500a, 500b, 500c, 500d and 500e) and a number of dielectric layers 504 (500a, 500b, 500c and 500d). In some embodiments, each dielectric consists of a bulk single crystal or crystal film.

As shown in FIG. 4, each dielectric layer 504 is disposed between a pair of electrode layers 502 in an interleaved manner. For example, dielectric 504a is sandwiched between electrode 502a and 502b but one edge of each dielectric protrudes from between the two electrode layers. Likewise each electrode layer also protrudes at one edge, creating an interleaved structure as shown. As further shown in FIG. 4, exemplary device 500 is a two terminal device. More specifically, device 500 includes terminals 510 and 511. In the embodiment shown, electrodes 502a,c,e are electrically connected to terminal 510 and electrodes 502b,d are electrically connected to terminal 511. As further shown in FIG. 4, device 500 may include a substrate 590 on which the multilayer capacitor 501 is disposed.

FIGS. 5A-5E illustrate a preferred stepwise process for making multilayer capacitor 501 with an interleaved structure. This process begins with placing a mask 690 on substrate 590 (step 1) to guide placement of a first conductor 601a on the substrate. See FIG. 5A. Next (step 2), the mask 690 is shifted by an amount (Δx) in a first direction. See FIG. 5B, indicating Δx as movement to the left as indicated by the arrow. Next (step 3), a dielectric 602a is placed on top of the conductor using the mask as a guide. Using this method, because the mask is shifted in the first direction by Δx, a portion of conductor 601a is not covered by dielectric 602a. Next (step 4), the mask 690 is again shifted by an amount (Δx) in the first direction. See FIG. 5C, indicating Δx as movement to the left as indicated by the arrow. Next (step 5), the mask is used to guide placement of a conductor 601b on top of dielectric 602a. Because the mask was shifted in the first direction, a portion of dielectric 602a is not covered by conductor 601a. Next (step 6), the mask 690 is shifted by an amount (Δx) in a second direction, which is opposite the first direction. See FIG. 5D, indicating Δx as movement to the right as indicated by the arrow. Next (step 7), a dielectric 602b is placed on top of the conductor 601b, using the mask as a guide. Next (step 8), the mask 690 is again shifted by an amount (Δx) in the second direction. See FIG. 5E, indicating Δx as movement to the right as indicated by the arrow. Next (step 9), a conductor 601c is placed on top of dielectric 602b using this mask placement. Although this Figure exemplifies a stacked capacitor with two dielectric layers, alternate embodiments, for example comprising 3, 4, 5, 6, 7 or more dielectric layers, each disposed between two conductors analogous to the diagram of FIG. 5E, also are contemplated. The amount of movement of the mask, Δx, may be any suitable amount in any direction. The amount may be the same in each instance or may vary between steps.

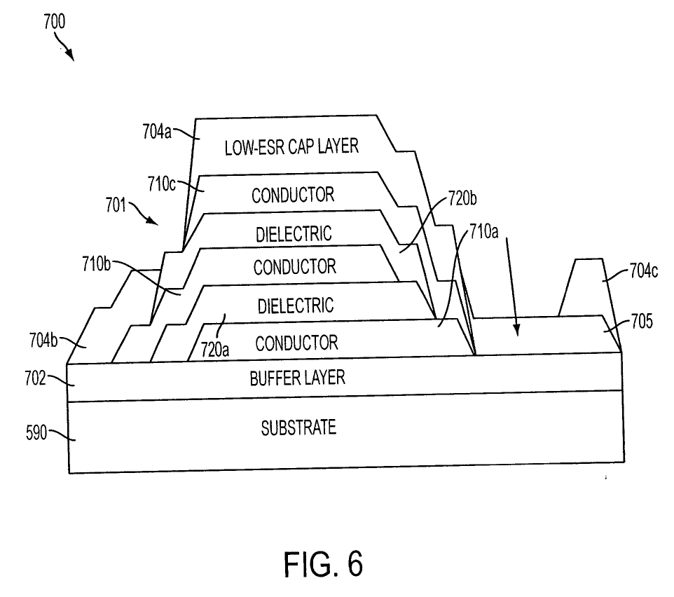

Substrate 590 may be any suitable substrate and conductor 601 may be any suitable conductor. For example, substrate 590 may include or consist of an oxide substrate (e.g., LaAlO₃ (LAO)) and conductors 601 may include or consist of: La₂₋ₓSrₓCuO₄ (LSCO) wherein x=0.18 to 0.30; La₁₋ₓSrₓCoO₄ (LSCoO) wherein x=0.5; LaNiO₃ (LNO); SrRuO₃ (SRO); or any combination thereof. In some embodiments, a base layer or buffer layer optionally is positioned between substrate 590 and conductor 601a. This feature is illustrated in FIG. 6. Additionally, in some embodiments, the last of the dielectric and conductor films added to the capacitor have smaller area to permit a thick, low-effective series resistance (ESR) capacitor layer, for example a low-ESR gold film, to conduct in parallel with both electrodes. This feature also is illustrated in FIG. 6.

FIG. 6 illustrates an energy storage device 700 according to an embodiment of the invention. Device 700 is similar to device 500 in that device 700 includes multilayer capacitor 701, which comprises conductor layers 710a, 710b and 710c and dielectric layers 720a and 720b disposed on substrate 590. Device 700 also includes the optional features of (a) a buffer layer 702 disposed between capacitor 701 and substrate 590, (b) a high-conducting capping layer 704a deposited on the outer conductor 710c of capacitor 701 to lower the capacitor's effective series resistance (ESR) and (c) second and third low-ESR layer contacts 704b and 704c deposited on the outer conductor 710b and 710c of capacitor 701. The low-ESR layers may include or consist of gold, silver, copper or any other high-conductivity metal. FIG. 6 also depicts a thin-film fuse 705, which optionally forms part of the device 700. The fuse may include or consist of a conductive film that cannot carry as much current as the electrode layers without overheating and evaporating. Low-ESR layer contact 704c contacts conductor 710c via thin film fuse 705 and low ESR cap 704a.

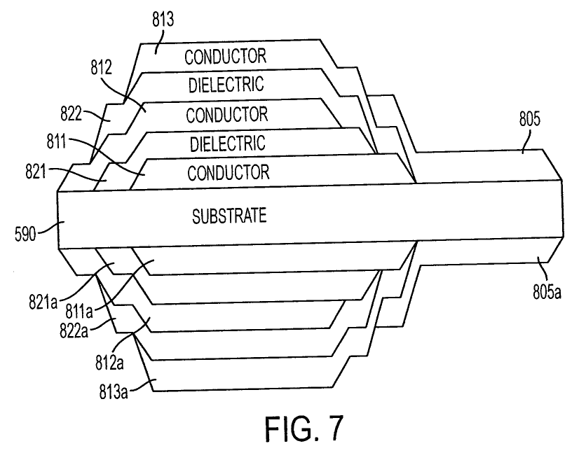

FIG. 7 illustrates an energy storage device 800 according to an embodiment of the invention. Energy storage device 800 is similar to energy storage devices 500 and 700 except that energy storage device 800 includes two conductor and dielectric stacked layers, each on opposite sides of substrate 590. The stacked layers on one side comprise conductors 811, 812, and 813 and dielectrics 821 and 822 on one side of the substrate 590 and conductors 811a, 812a and 813a and dielectrics 821a and 822a on the opposite side of the substrate 590. FIG. 7 illustrates an embodiment which comprises two thin film fuses 805 and 805a, one on either side of substrate 590.

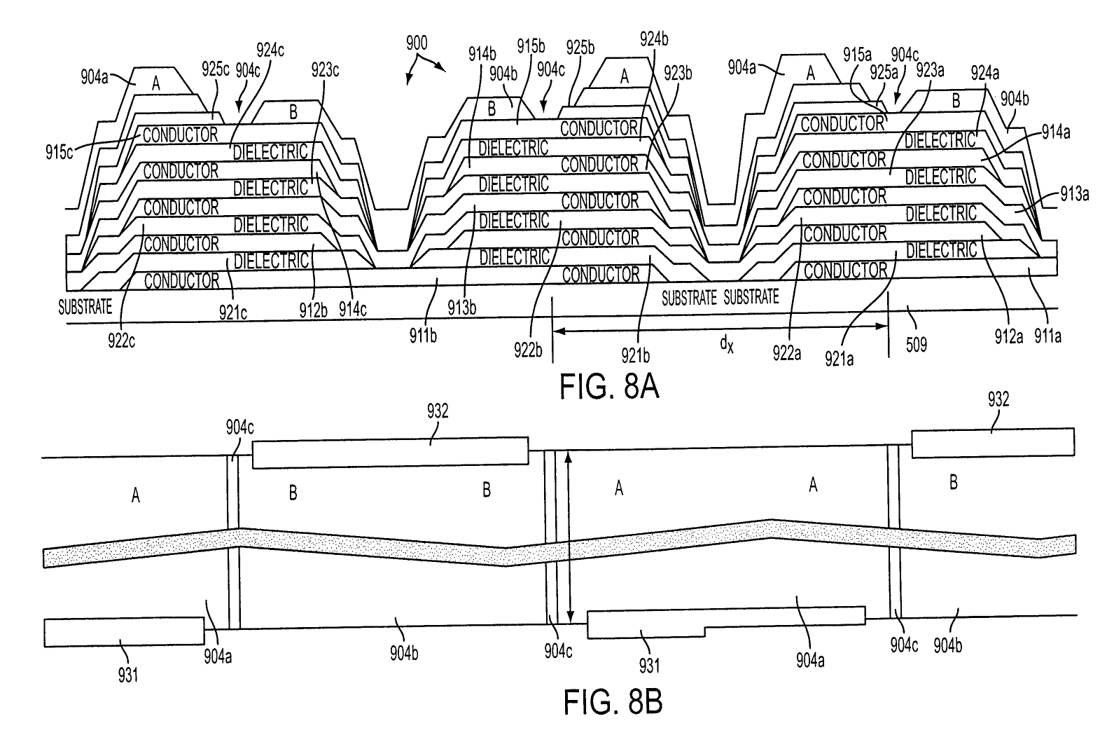

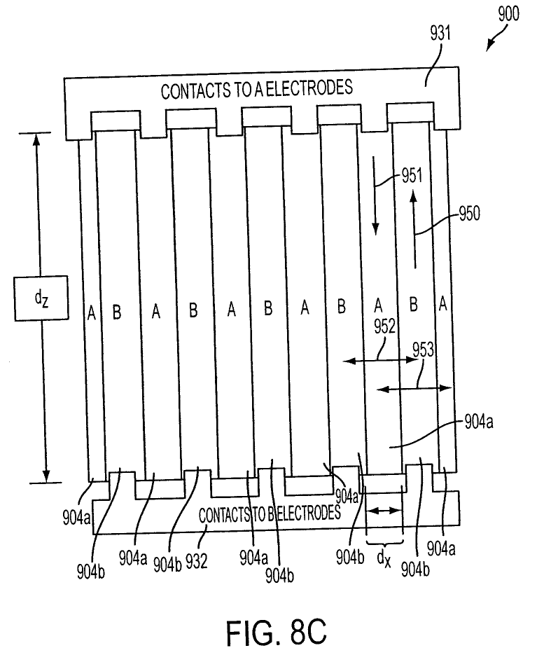

FIGS. 8A-8C illustrate an energy storage device 900 according to another embodiment of the invention. In this embodiment, the effect of a high-electrical-conductivity electrode layer, patterned as stripes A and B, to work in parallel with lower-conductivity-multilayer electrodes to reduce the effective series resistance (ESR) of the capacitor is maximized. In this way, the buried electrode layers may be optimized for some property other than high electrical conductivity, while the top layer is optimized for high conductivity. In particular, the buried electrode layers may be optimized to provide a template for growth of crystalline orientation or single crystal growth of the dielectric layers.

Energy storage device 900 is similar to device 700, however device 900 comprises a series of capacitors. Energy storage device 900 is made up of a series of stacked conductor layers 911a, 911b, 912a, 912b, 913a, 913b, 914a, 914b, 915a, and 915b and dielectric layers 921a, 921b, 921c, 922a, 922b, 922c, 923a, 923b, 923c, 924a, 924b, 924c, 925a, 925b, and 925c. The conductor layers advantageously are configured and layered upon the substrate such that every other conductor layer continues from one capacitor stack to its neighbor on one side while the remaining conductor layers continue in the same manner to their neighbor on the other side as shown in the FIG. 8A, thus creating multiple capacitors in parallel.

The width of the stripes of the high-conductivity top electrode, dₓ, should be about ten times greater than their length, dₓ, to gain a geometric advantage. See FIG. 8C. The advantage is that current flowing in the x direction in the low conductivity buried electrodes only travels a fraction of the distance that it travels in the z direction in the high-conductivity top electrode. Therefore, for a typical 1 cm×1 cm square capacitor chip, dₓ is approximately 1 mm while d_{z} is 10 mm. The longer path length in the high-conductivity layer adds some series resistance, but is more than compensated by the order-of-magnitude reduction in the resistance of the low-conductivity layers for a net reduction in ESR.

FIG. 8B illustrates the capacitor device 900 above in a top view. Low-ESR material 904a and 904b overlays the capacitors with a gap 904c present at or near the center of each multilayer capacitor stack. Material 904a contacts to a current bus 931 while material 904b contacts to a second current bus 932 as illustrated. The dark horizontal line is intended to indicate a discontinuity in the vertical scale of the drawing. The A and B stripes of high-conductivity material are actually much longer-for example 10 times longer-in the vertical, z, direction than they are in the horizontal, x, direction.

A low-ESR material 904 is layered over the capacitors in alternating series of halves 904a and 904b (each alternating portion contacting the same current bus), with a gap 904c between them on each multilayer capacitor stack. The low-ESR materials 904a and 904b are configured to overlay the area between adjacent multilayer capacitor stacks while leaving a gap 904c at or near the center of each multilayer capacitor stack which is not overlayered with the low-ESR material. Preferably, this low-ESR material is a thick (about 1 μm to about 10 μm thick layer of gold, silver, copper or other high-conductivity metal.

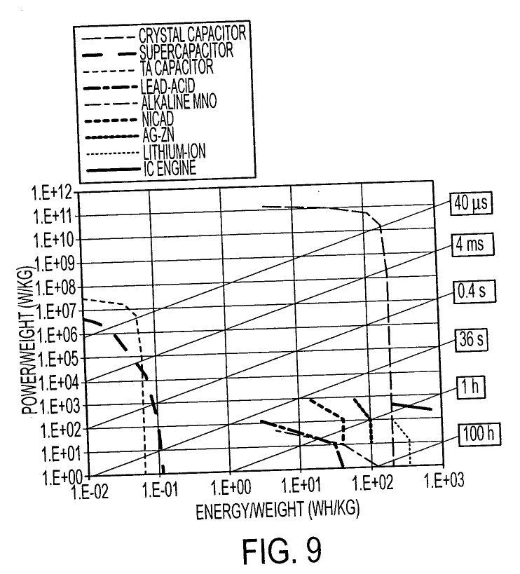

In capacitors of this type, a parallel set of capacitors can substitute for a single capacitor of equal area. For example a capacitor of 1 unit² can be replaced by a capacitor according to the embodiment illustrated in FIGS. 9A and 9B which comprises 10 capacitors in parallel, each of 0.1 unit². Addition of a thick gold layer on top of the capacitor multi-layer stack in two alternating series of halves improves the speed of discharge for the top capacitor. While using a number of smaller capacitors rather than one large capacitor results in adding series resistance to the gold bus-line, this geometry speeds up overall discharge since each conductor layer has fewer squares of resistor in series (one twentieth of a square in the 10:1 example shown in FIG. 8A). Although a 10:1 ratio is preferred in some embodiments, the skilled person will recognize that different ratios, for example 5:1, 8:1, 12:1, 15:1 or others can be used and fall within what is contemplated for the invention. The geometry of charge storage devices according to this embodiment, combined with the thick low-ESR overlay, provides a device which reduces problems associated with ESR_{ρ}.

FIG. 8C illustrates a further embodiment of a full chip of the invention in top view, the same view as in FIG. 8B. In this embodiment, the energy storage device 900 is a capacitor chip divided into ten sections. Energy storage device 900 is a specific embodiment of the energy storage device exemplified by the illustrations in FIGS. 8A and 8B. Low-ESR material 904a and 904b are layered alternately over ten adjacent capacitor stacks as depicted in FIG. 8A. In this embodiment, the length of the capacitor stacks (d_{z}) is equal to ten times the width of each capacitor (dₓ). Low-ESR material 904a contacts to a current bus 931 while material 904b contacts to a second current bus 932 as illustrated. Arrows 950-953 show the direction of current flow in the device.

CaCu₃Ti₄O₁₂ (CCTO) and its variants are good materials for use as the dielectric materials for thin-film and bulk crystal capacitors. CCTO exhibits an extremely high dielectric constant and relatively low loss tangent. The dielectric constant is approximately 80,000 at temperatures equal to or greater than 250 Kelvin for frequencies up to 1 MHz, while the loss tangent is on the order of 0.1 at room temperature and a frequency of less than 1 MHz. These characteristics make CCTO an ideal material for a capacitor with a single-crystal dielectric according to embodiments of the invention.

Although CCTO is a good candidate single-crystal dielectric material, other materials with similar perovskite-related crystal structures and similar chemical compositions can work as well or better. Substituting a fraction of calcium, copper, or titanium in CCTO with one or more similar ion can result in materials having the same or improved function. For example, in bulk ceramics, up to about 20% or more of the calcium ions in CCTO can be replaced by strontium. This particular substitution and related chemical substitutions (e.g., sodium and/or a rare earth element replacing calcium) are encompassed by the present invention. Any high-ε variant of CCTO which has the same modified-perovskite crystal structure may be used for crystal capacitors. Titanium can be replaced at least partially with tantalum, niobium, antimony or mixtures thereof.

Polycrystalline CCTO ceramic plates and thin films also may be used as dielectric materials in embodiments according to the invention. These materials are lower-cost and lower-performance alternatives to bulk single crystal capacitors as discussed above.

Polycrystalline CCTO thin films have a dielectric constant of approximately 1500 at temperatures above about 250 Kelvin for frequencies up to 1 MHz. Bulk polycrystalline CCTO ceramics exhibit a dielectric constant of 5,000 to 50,000, somewhat higher than that of corresponding films, but as much as an order of magnitude lower than that for single crystals.

Energy density and dielectric thicknesses for capacitors using these lower performance alternative materials have been projected. This information is contained in Table I, below. The energy density is the produce of the dielectric constant and the square of the maximum electric field, Eₘₐₓ. A factor of 3 margin of safety in the electric field strength was used in these calculations. Dielectric thickness is calculated from the operating voltage, electric field strength, and the safety margin. Energy density is greatest for input values typical of CCTO crystals.

TABLE I
Energy Density and Dielectric Thickness Projections
for Capacitors with Different Values of Dielectric Constant
and Maximum Electric Field Strength.

| | | | | safety | Dielec. | Energy |
|---|---|---|---|---|---|---|
| | Voltage | Dielec. | Eₘₐₓ | factor | Thickness | Density |
| Assumptions: | (V) | Const. | (V/μm) | (η) | (μm) | (J/cc) |
| Thin Film; | 50 | 1500 | 250 | 3 | 0.6 | 46 |
| high- | | | | | | |
| strength | | | | | | |
| Polycrystalline | 20,000 | 8000 | 80 | 3 | 750 | 25 |
| Ceramic; low- | | | | | | |
| strength | | | | | | |
| Single-Crystal; | 20,000 | 80,000 | 80 | 3 | 750 | 252 |
| low-strength | | | | | | |
| Polycrystalline | 20,000 | 8000 | 250 | 3 | 240 | 246 |
| Ceramic; high- | | | | | | |
| strength | | | | | | |
| Single-Crystal; | 20,000 | 80,000 | 250 | 3 | 240 | 2458 |
| high-strength | | | | | | |
| Single-Crystal; | 10,000 | 80,000 | 250 | 3 | 120 | 2458 |
| high-strength | | | | | | |
| Single-Crystal; | 50,000 | 80,000 | 250 | 3 | 600 | 2458 |
| high-strength | | | | | | |

The dielectrics and capacitors described herein may be used in pulse power applications and systems. Examples of pulse power system include directed energy weapons (e.g., railguns, free-electron lasers, and other directed energy weapons). FIG. 9 is a plot of specific power vs. specific energy for a number of energy storage technologies, commonly referred to as a Ragone plot. The Ragone plot illustrates the well-known fact that capacitors can deliver power much more rapidly than batteries or, for that matter, an internal combustion engine. The small time constant of capacitors is important for rapid discharge to deliver power to a load, and for applications such as directed energy weapons is equally important for rapidly re-charging to reduce time between pulses. The crystal capacitors disclosed herein are similar to other (commercial) capacitors with respect to their charge or discharge time. Thus, they also are much faster than batteries. However, the high energy density of the crystal capacitors compared with commercial capacitors greatly reduces the weight and volume of a capacitor bank which would be used for a pulse-power system. Therefore a capacitor bank of equal size and/or weight would be able to provide more power to the system.

The dielectrics and capacitors described herein also may be used in systems where one normally would use a battery. Table II presents data comparing a CCTO crystal capacitor to other capacitors and to some conventional batteries. The energy density in CCTO crystal capacitors is projected to be greater than that of batteries and about 3 orders of magnitude higher than the energy density of conventional capacitors. In general, capacitors have slightly greater mass density than batteries but the energy/weight of CCTO crystal capacitors according to embodiments of the invention is still comparable to a wide selection of battery technologies. See Table II, below. The data for CCTO crystal capacitors in Table II are projected while other data represent typical published values.

TABLE II
Projected Characteristics of Selected Energy
Storage Devices.

| | Energy | Mass | Energy/ |
|---|---|---|---|
| | Density | Density | Weight |
| Storage Type | (J/cc) | (g/cc) | (Wh/kg) |
| CCTO Crystal | 2500 | 3.44 | 202 |
| Capacitor | | | |
| Ta Capacitor | 1 | 4.94 | .01 |
| Supercapacitor | 2 | 4.00 | .01 |
| Lead-acid | 360 | 2.47 | 41 |
| Battery | | | |
| Alkaline Long- | 1152 | 2.88 | 110 |
| life Battery | | | |
| Carbon-zinc | 331 | 2.55 | 36 |
| Battery | | | |
| NiMH Battery | 1080 | 3.18 | 95 |
| NiCad Battery | 504 | 3.60 | 39 |
| Lithium-ion | 828 | 1.80 | 128 |
| Battery | | | |
| Gasoline | 34,346 | 0.74 | 12,945 |

In summary, embodiments of the invention include capacitors with superior charge density which comprise a dielectric which is a multilayer thin film or single crystal of either CCTO or a derivative of CCTO in which part of one or more of the ions in the material, for example calcium, copper, titanium or a combination thereof, has been replaced with another ion. As an alternative to producing the dielectric as a single crystal of the desired dimensions for use in the capacitor, dielectrics according to the invention also may be manufactured by growing a boule of dielectric material, cutting the boule into parallel-sided wafers of appropriate dimensions, and polishing the wafers. In addition, some embodiments of the invention relate to capacitors in which the dielectric is a ceramic tape or film. These capacitors advantageously may be used for pulse power applications, electric vehicles, or for any energy storage application, for example where a battery customarily would be used.

While various embodiments/variations of the present invention have been described above and in the Examples below, it should be understood that they have been presented by way of example only, and not limitation. Thus, the breadth and scope of the present invention should not be limited by any of the above-described exemplary embodiments, but should be defined only in accordance with the following claims and their equivalents. Additionally, while the process described above and illustrated in the drawings is shown as a sequence of steps, this was done solely for the sake of illustration. Accordingly, it is contemplated that some steps may be added and other steps omitted, and the order of the steps may be re-arranged.

### EXAMPLES

### Example 1

### Fabrication of CCTO Samples and CCTO-Based Capacitors

Capacitors were fabricated using epitaxial thin film CCTO crystals and their characteristics measured. Epitaxial thin film electrodes approximately 0.2 μm thick of either La-Sr-Cu-O or La-Sr-Co-O were deposited on single-crystal lanthanum aluminate substrates by either pulsed laser ablation or sputtering. CCTO dielectric films 0.1 to 0.2 μm thick were deposited either on these pre-coated substrates or on conductive substrates of niobium-doped strontium titanate single crystals by either pulsed laser ablation or sputtering. Top electrodes of either La-Sr-Cu-O or gold were deposited and patterned to complete parallel-plate capacitor structures. The dielectric properties of these capacitors were stable up to a maximum field strength, Eₘₐₓ, of 250 V/μm.

Capacitors also were fabricated with bulk, polycrystalline ceramic samples of CCTO. These samples were fabricated from copper oxide, titanium oxide, and calcium carbonate starting powders. After calcining, the powders were pressed into 1 mm thick pellets and sintered at temperatures up to 1100° C. Silver electrodes were used to complete parallel-plate capacitor structures. Dielectric constants at room temperature and 1 kHz were as large as 50,000.

What is claimed is:

1. A parallel plate capacitor which comprises a bulk single crystal or single crystal film dielectric.

2. A capacitor, comprising:
a first electrode;
a second electrode; and
a bulk single crystal or single crystal film dielectric disposed between and contacting said first electrode and said second electrode.

3. A capacitor, comprising:
a first electrode;
a second electrode; and
a ceramic tape dielectric disposed between and contacting said first electrode and said second electrode.

4. The capacitor of claim 1, wherein said dielectric consists essentially of CaCu₃Ti₄O₁₂.

5. The capacitor of claim 1, wherein the dielectric consists essentially of Ca₁₋ₓSrₓCu₃Ti₄O₁₂, where X is greater than or equal to 0 and less than or equal to 1.

6. The capacitor of claim 5, wherein X is greater than or equal to 0 and less than or equal to 0.2.

7. The capacitor of claim 5, wherein X is greater than or equal to 0 and less than or equal to 0.1.

8. The capacitor of claim 1, wherein the dielectric has a perovskite structure.

9. An energy storage device which comprises one or more capacitors according to claim 1.

10. A pulse-power system comprising a capacitor according to claim 1.

11. An electric vehicle comprising an energy storage system, wherein said energy storage system comprises a capacitor according to claim 1.

12. The capacitor of claim 3, wherein the ceramic is a polycrystalline ceramic.

13. A capacitor energy storage device comprising at least one multilayer interleaved structure of thin-film dielectric and electrode layers, wherein said dielectric layers each are positioned between two electrode layers but protrude from between said electrode layers at one edge.

14. The capacitor energy storage device of claim 13 wherein said thin-film dielectric layer is a single crystal.

15. The capacitor energy storage device of claim 13 wherein said dielectric is CCTO.

16. The capacitor energy storage device of claim 15 wherein said CCTO is a polycrystalline thin-film.

17. The capacitor energy storage device of claim 15 wherein said CCTO is a single crystal.

18. The capacitor energy storage device of claim 13 wherein said conductor is selected from the group consisting of La₂₋ₓSrₓCuO₄ and La₁₋ₓSrₓCoO₄

19. The capacitor energy storage device of claim 13 which further comprises a substrate layer of having at least 2 opposite sides wherein said multilayered interleaved structure is positioned on one side of said layer.

20. The capacitor energy storage device of claim 19 wherein said substrate is LaAlO₃

21. The capacitor energy storage device of claim 19 wherein said multilayered interleaved structure is positioned on one side of said substrate layer and a second multilayered interleaved structure is positioned on the opposite side of said substrate layer.

22. The capacitor energy storage device of claim 13 further comprises a fuse.

23. The capacitor energy storage device of claim 13 which further comprises a capping layer placed over said multilayered interleaved structure, wherein said capping layer is a high-conductivity metal.

24. The capacitor energy storage device of claim 23 wherein said high-conductivity metal is selected from the group consisting of gold, silver and copper.

25. The capacitor energy storage device of claim 13 wherein at least two of said multilayer interleaved structures of thin-film dielectric and electrode layers are placed in parallel.

26. The capacitor energy storage device of claim 13 which is made using a mask.

27. A process of making the capacitor energy storage device of claim 13 using a mask.
